(19) United States
(12) Patent Application Publication
(10) Pub. No.: US 2019/0130883 A1
(43) Pub. Date: May 2, 2019

(54) SET TOP BOX WITH KARAOKE FUNCTIONS

(71) Applicant: GloryKylin International Co., Ltd., Tainan (TW)

(72) Inventor: Hui-Tang CHEN, Tainan (TW)

(21) Appl. No.: 15/933,426

(22) Filed: Mar. 23, 2018

(30) Foreign Application Priority Data
Oct. 30, 2017 (TW) 106216047

(51) Int. Cl. G10H 1/36; H04N 21/439

(52) U.S. Cl. CPC G10H 1/368; G10H 1/366; G10H 2220/455; G10H 1/365; H04N 21/439

(57) ABSTRACT

The invention provides a set top box with karaoke functions. The invention consists of a video and audio real-time casting function processor, an audio/video decoding processor with high definition multimedia interface technology and an audio remix processor. Therefore, the multimedia image can be projected onto a large screen and the output audio and the microphone sound can be mixed together and then output to the audio equipment, so as to achieve a better karaoke singing result.

### BACKGROUND OF THE INVENTION

### 1. Field of the Invention

This invention relates to a set top box with karaoke functions, in particular which can output the multimedia audio and mix it with microphone sound, and then output to the audio equipment in order to improve the experience of audio and video effects at the karaoke site.

### 2. Description of the Prior Art

Currently, the karaoke box used for karaoke singing features the installation of a karaoke application (APP) in the Android box, after decoding the audio output with MCU, mixing with microphone sound, and using audio cable to connect audio equipment through the audio output port to output the sound, the video is output to a display screen such as television. Another approach is to connect intelligent terminal equipment through Bluetooth or wire, merely mixing the audio input and the microphone sound and then outputting to the audio equipment. However, this method of processing karaoke multimedia audio with MCU through installing karaoke APP in the Android box at present has the shortcomings of perceivable delay in human audition, inconvenient search of songs, and slow response, making it impossible to experience the high-quality effect at the karaoke site.

### SUMMARY OF THE INVENTION

The objective of this invention is to solve the asynchrony with video images caused by audio delay, so that users can have better sensory experience on karaoke audio and video effects.

The main characteristics of the invention is provides a kind of set top box with karaoke functions, it includes a video and audio real-time casting function processor,which is mainly to achieve Wi-Fi connection from intelligent terminal equipment, and to download and play the multimedia of karaoke songs. An audio/video decoding processor, which is equipped behind the video and audio real-time casting function processor, mainly to receive signals from the video and audio real-time casting function processor, and send signals to the audio remix processor, as well as receive returning signals. An audio remix processor, which is connected with the audio/video decoding processor, mainly to receive and process the audio receiving module and A/D converter of the microphone, it is able to process the audio module and audio signal received by mixing them with sound effects, and then send them back to the audio/video decoding processor for output. The present invention can provide better audio and video output by the composition of the above components.

### BRIEF DESCRIPTION OF DRAWINGS

This invention will be understood by referring to the accompanying drawings, wherein:

FIG. 1 is a connecting operation example of the present invention;

FIG. 2 is a functional and schematic module diagram of the present invention.

### DETAILED DESCRIPTION OF THE PREFERRED EMBODIMENT

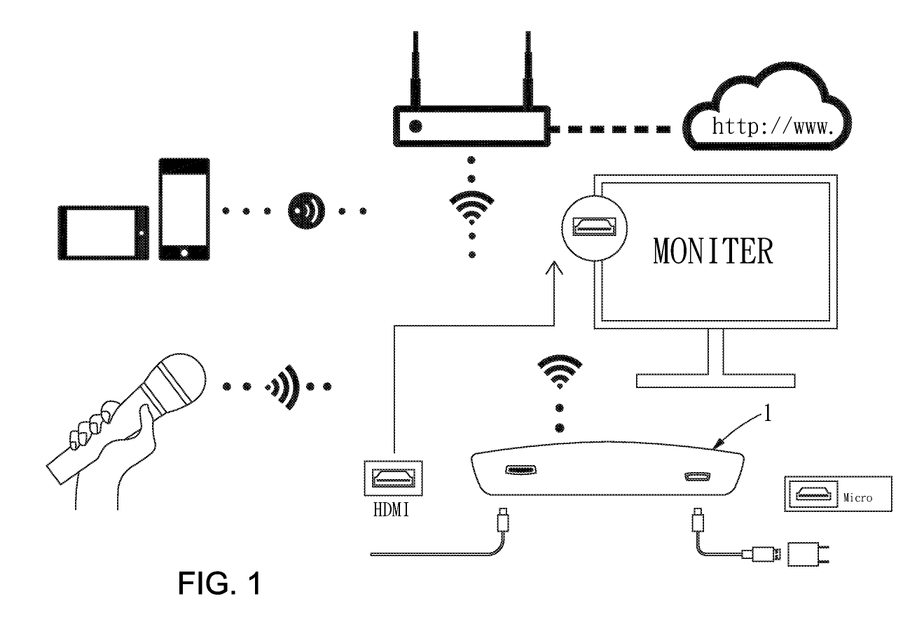

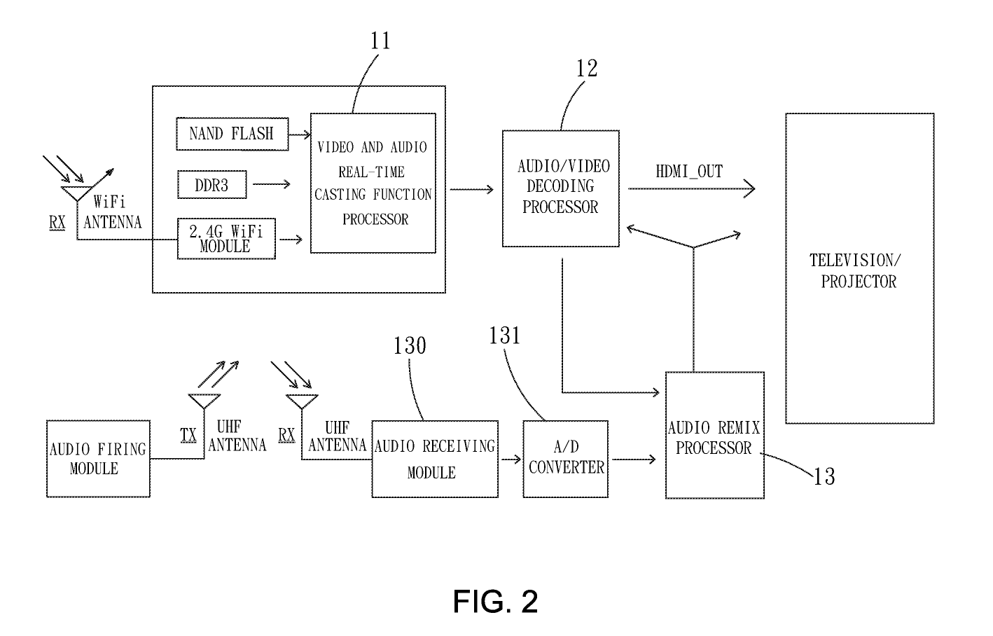

As shown in FIGS. 1-2, a preferred embodiment consists mainly of a set top box with karaoke functions 1 is composed of a video and audio real-time casting function processor 11, an audio/video decoding processor 12 and an audio remix processor 13.

The video and audio real-time casting function processor is mainly to receive Wi-Fi connection from intelligent terminal equipment, and to download and play the multimedia of karaoke songs. The audio/video decoding processor 12 is mainly to receive signals from the video and audio real-time casting function processor 11 and send signals to the audio remix processor 13, as well as receive returning signals. The audio remix processor 13 is mainly to receive and process the audio receiving module 130 and A/D converter 131 of the microphone, it is able to process the received audio module and video signals of the audio/video decoding processor 12 by mixing them with sound effects, and then send them back to the audio/video decoding processor 12 for the final output to a television or projector.

The present invention is mainly to receive audio signals (first audio signals) and video signals of the audio/video decoding processor 12 (second audio signals) by the audio remix processor 13. The audio remix processor 13 performs the sound mixing and tuning process on the first and second audio signals, outputs the mixed and tuned audio signals to the audio/video decoding processor 12, performs the synthesis and then outputs to a television or projector after separating the mixed and tuned audio signals from the audio frequency.

The invention has the following advantages as can be seen from the foresaid description.

1. The present invention, a set top box with karaoke functions, is mainly able to perform separation of the projecting video and audio of the microphone, and then carry out the sound mixing process, which allows the output video to achieve more optimized karaoke sound effects.

While the preferred embodiment of the invention has been described above, it will be recognized and understood that various modifications may be made therein and the appended claims are intended to cover all such modifications that may fall within the spirit and scope of the invention.

What is claimed is:

1. A set top box with karaoke functions mainly comprising:
a video and audio real-time casting function processor, mainly to achieve Wi-Fi connection from intelligent terminal equipment, and to download and play the multimedia of karaoke songs;
an audio/video decoding processor, equipped behind said video and audio real-time casting function processor, mainly to receive signals from said video and audio real-time casting function processor, and send signals to the audio remix processor, as well as receive returning signals;
an audio remix processor, connected with said audio/video decoding processor, mainly to receive and process the audio receiving module and A/D converter of the microphone, it is able to process the audio module and audio signal received by mixing them with sound effects, and then send them back to the said audio/video decoding processor for output; and
The present invention can provide better audio and video output by the composition of the above components.

2. The set top box with karaoke functions as claimed in claim 1 wherein said audio remix processor is capable of optimizing sound quality and sound effects.
